(19) United States
(12) Patent Application Publication
(10) Pub. No.: US 2025/0389855 A1
(43) Pub. Date: Dec. 25, 2025

(54) SOLAR IRRADIANCE PREDICTION SYSTEM AND METHOD FOR SOFT X-RAYS AND EUV WAVELENGTH RANGES

(71) Applicant: KOREA ASTRONOMY AND SPACE SCIENCE INSTITUTE, Daejeon (KR)

(72) Inventors: Jeong-Heon KIM, Sejong-si (KR); Junmu YOUN, Hwaseong-si (KR); Sung-Hong PARK, Sejong-si (KR); Seungwoo AHN, Yongin-si (KR); Kangwoo YI, Yongin-si (KR); Seonghwan CHOI, Daejeon (KR); Young-Sil KWAK, Daejeon (KR); Yong-Jae MOON, Yongin-si (KR)

(73) Assignee: KOREA ASTRONOMY AND SPACE SCIENCE INSTITUTE, Daejeon (KR)

(21) Appl. No.: 19/240,278

(22) Filed: Jun. 17, 2025

(30) Foreign Application Priority Data
Jun. 24, 2024 (KR) 10-2024-0081838

(51) Int. Cl. G01T 1/17

(52) U.S. Cl. CPC G01T 1/17

(57) ABSTRACT

The present disclosure relates to a solar irradiance prediction system and method of soft X-rays and EUV wavelength ranges. The present disclosure relates to a technology capable of predicting and providing solar irradiance within the entire wavelength range that may affect the Earth's ionosphere based on a time when solar flare alert is issued.

### CROSS-REFERENCE TO RELATED APPLICATIONS

This application claims the benefit of priority under 35 U.S.C. § 119 to Korean Patent Application No. 10-2024-0081838, filed Jun. 24, 2024, the content of which is incorporated herein by reference in its entirety.

### TECHNICAL FIELD

The following disclosure relates to a solar irradiance prediction system and method for soft X-rays and EUV wavelength ranges, and more particularly, to a solar irradiance prediction system and method for soft X-rays and EUV wavelength ranges capable of predicting and issuing alerts for space weather by rapidly estimating solar irradiance in these wavelength ranges based on the time when a solar flare alert is issued at level M1 or higher.

### BACKGROUND

When a solar flare occurs, solar irradiance corresponding to a soft-X rays wavelength range (0.1 to 5 nm) and an EUV wavelength range (5 to 105 nm) increases by tens to hundreds of times and is emitted. When the emitted solar irradiance reaches the Earth, it causes a rapid increases in the electron density of the Earth's ionosphere.

More specifically, soft X-rays increase the electron density in the D and E layers of the ionosphere, leading to the Dellinger effect, while EUV irradiance increase the electron density in the F layer, disrupting ground-to-satellite radio communications and causing signal delays.

Therefore, when the solar flare alert is issued, there is a demand to predict changes in space weather and issue appropriate alerts. However, there is currently no technology to predict changes in solar irradiance for the entire wavelength range.

Moreover, due to the characteristics of the solar flare and the resulting space weather effects, there is a need for a technology that can analyze not only the time the alert is issued, but also the delayed and lasting impacts on the Earth's ionosphere, and accordingly predict changes in solar irradiance for the entire wavelength range.

### SUMMARY

An embodiment of the present disclosure is directed to providing a solar irradiance prediction system and method of soft X-rays and EUV wavelength ranges. The system is capable of predicting and issuing alerts for space weather disturbances caused by solar flares, by rapidly calculating and providing predicted solar irradiance values in the soft X-ray and EUV ranges when a solar flare alert is issued.

In one general aspect, a solar irradiance prediction system of soft X-rays and EUV wavelength ranges includes: when solar flare alert of a preset level or higher is issued, a data input unit that receives preset data items related to an issued solar flare alert; a data pre-processing unit that analyzes the data received by the data input unit to extract irradiance data from an occurrence time to a preset first time before based on a time when a corresponding solar flare alert is issued and convert the extracted irradiance data into a preset time unit; a model processing unit that inputs the irradiance data converted by the data pre-processing unit to a stored training model, and receives predicted irradiance data in the soft-X rays and EUV wavelength ranges; and a data post-processing unit that converts the predicted irradiance data output from the model processing unit into an energy unit and generates a predicted solar irradiance value.

The data input unit may include, as the preset item, the following: level information, occurrence time information, the occurring location, and irradiance data in the soft-X rays wavelength range, as measured by geostationary operational environmental satellite (GOES) at the time when the solar flare alerts is issued.

The model processing unit may output the predicted irradiance data from the occurrence time to a preset second time.

The solar irradiance prediction system may include the following components: a data collection unit that collects data of a preset item for solar flare alerts issued in the past; a data extraction unit that analyzes the data collected by the data collection unit and sets data for generating training data; a data generation unit that extracts, for each issued solar flare alert, the irradiance data using the data set by the data extraction unit and converts the extracted irradiance data into the preset time unit to generate a training data set; and a training processing unit that performs training on the training data set generated by the data generation unit using a pre-stored artificial intelligence algorithm to generate a training model, in which the training model according to a training processing result of the training processing unit is a training model stored in the model processing unit.

The data collection unit of the model processing unit may include: a first collection unit that collects, for each solar flare alert issued in the past, level information, occurrence time information, an occurring location, and irradiance data in the soft-X rays wavelength range by GOES before a preset first time based on the time when the corresponding solar flare alert is issued; and a second collection unit that collects, using a linked observation database, the irradiance data in the soft-X rays wavelength range and irradiance data in the EUV wavelength range corresponding to the data collected by the first collection unit, and the second collection unit may collect data for the preset second time using the linked observation database based on the time when the corresponding solar flare alert is issued.

The data extraction unit of the model processing unit may include: a first extraction unit that analyzes the data collected by the data collection unit and extracts data by the solar flare alert of a preset level or higher; a second extraction unit that analyzes the data extracted by the first extraction unit, and removes data by the corresponding solar flare alert, when the solar flare alert of the preset level or higher is issued duplicately from the occurrence time to the preset first time before based on the time when the corresponding solar flare alert to the preset first time; a third extraction unit that analyzes data remaining after being removed by the second extraction unit, and removes the data by the corresponding solar flare alert when the corresponding solar flare alert of the preset level or higher is issued duplicately from the occurrence time to the preset second time based on the time when the corresponding solar flare alert is issued; and a final processing unit that sets the data remaining after being removed by the third extraction unit as the data for generating the training data.

In another general aspect, a solar irradiance prediction method of soft-X rays and EUV wavelength ranges, executed by a solar irradiance prediction system in which each step is performed by an operation processing means, comprises: a data input step (S100), in which a data input unit receives, as data of a preset item for an issued solar flare alert of a preset level or higher, the flare level information, occurrence time information, an occurring location, and irradiance data in the soft-X rays wavelength range by a geostationary operational environmental satellite (GOES) of the a time when the solar flare alert is issued; a data pre-processing step (S200), in which a data pre-processing unit analyzes, the data received to extract irradiance data from the occurrence time to a preset first time before based on the time when the corresponding solar flare alert is issued, and converts the extracted irradiance data into the preset time unit; a model processing step (S300), in which a model processing unit inputs the irradiance data converted by the data pre-processing step (S200) into a stored training model and obtains predicted irradiance data in the soft-X rays and EUV wavelength ranges from the occurrence time to a preset second time based on the time when the corresponding solar flare alert is issued; and a data post-processing step (S400), in which a data post-processing unit converts the predicted irradiance data output by the model processing step (S300) into an energy unit and generates the final predicted solar irradiance data.

The solar irradiance prediction method may further include, prior to performing the model processing step (S300), the following step: a data collection step (S10), in which a data collection unit collects data of a preset item for solar flare alert issued in the past; a data extraction step (S20), in which a data extraction unit analyzes the data collected in the data collection step (S10) and prepares it for use in generating training data; a data generation step (S30) in which a data generation unit, for each issued solar flare alert, extracts the irradiance data using the configuration set by the data extraction step (S20), and converts the extracted irradiance data into a preset time unit to generate a training data set; and a training processing step (S40), in which a training processing unit trains a model using the dataset generated in the data generation step (S30) and a pre-stored artificial intelligence algorithm. the resulting model may be used as the training model in the model processing step (S300).

The data collection step (S10) may include the following substeps: a first collection step (S11), in which, for each solar flare alert issued in the past, level information, occurrence time information, an occurring location, and irradiance data in the soft-X rays wavelength range by GOES before a preset first time based on the time when the corresponding solar flare alert is issued; and a second collection step (S12), in which, using a linked observation database, the irradiance data in the soft-X rays and EUV wavelength range corresponding to the data collected in the first collection step (S11). In this step (S12), data for the preset second time may be collected using the linked observation database based on the time when the corresponding solar flare alert is issued.

The data extraction step (S20) may include the following substeps: a first extraction step (S21), in which the collected data is analyzed and filtered to extract entries corresponding to solar flare alerts of a preset level or higher; a second extraction step (S22), in which the data extracted by the first extraction step (S21) is analyzed, and any entries are removed when duplicate alerts of the preset level or higher is issued between the alert time and a preset second time; a third extraction step (S23), in which the remaining data is analyzed again, and entries are removed when duplicate alerts of the preset level or higher is issued between the alert time and a preset second time; and a final processing step (S24), in which the data remaining after being removed by the third extraction step (S23) is designated as the training data.

### BRIEF DESCRIPTION OF THE DRAWINGS

FIG. 1 is an exemplary configuration diagram illustrating a solar irradiance prediction system of soft X-rays and EUV wavelength ranges according to an embodiment of the present disclosure.

FIG. 2 is an exemplary diagram illustrating a structure of an artificial intelligence algorithm by the solar irradiance prediction system and method of soft X-rays and EUV wavelength ranges according to an embodiment of the present disclosure.

FIGS. 3A-3D, 4A-4D, 5A-5D and 6A-6D are diagrams comparing predicted irradiance data output by a solar irradiance prediction system and method of soft X-rays and EUV wavelength ranges according to an embodiment of the present disclosure with observed irradiance data.

FIG. 7 is an exemplary diagram illustrating solar irradiance prediction of soft-X rays and EUV wavelength ranges according to an embodiment of the present disclosure.

### DETAILED DESCRIPTION OF EMBODIMENTS

Hereinafter, a solar irradiance prediction system and method of soft X-rays and EUV wavelength ranges having the above-described configuration according to the present disclosure will be described in detail with reference to the attached drawings. Drawings to be provided below are provided by way of example so that the spirit of the present disclosure may be sufficiently transferred to those skilled in the art. Therefore, the present disclosure is not limited to drawings to be provided below, but may be implemented in other forms. In addition, like reference numerals denote like components throughout the specification.

Technical terms and scientific terms used herein have the general meaning understood by those skilled in the art to which the present disclosure pertains unless otherwise defined, and a description for a known function and configuration unnecessarily obscuring the gist of the present disclosure will be omitted in the following description and the accompanying drawings.

In addition, a system refers to a set of components including devices, mechanisms, means, and the like, systematized in order to perform required functions and regularly interacting with each other.

A solar irradiance prediction system and method for soft X-rays and EUV wavelength ranges, according to an embodiment of the present disclosure, calculates and provides predicted irradiance values for these wavelength ranges over a period of at least three hours following the issuance of a solar flare alert in real time. Accordingly, it enables real-time prediction and alerting of space weather from the time when the solar flare alert is issued to three hours afterward.

This may be provided as a reference value that may respond in real time to very important radio disturbances in the near-Earth space environment, and has a great advantage in detecting the changes in the space weather in the entire ionosphere by predicting not only the soft-X rays but also the EUV range.

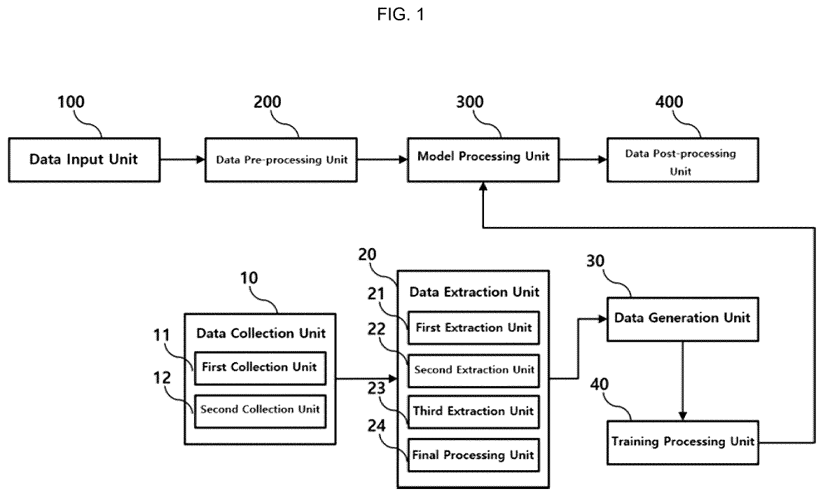

FIG. 1 is an exemplary configuration diagram illustrating a solar irradiance prediction system of soft X-rays and EUV wavelength ranges according to an embodiment of the present disclosure. As illustrated in FIG. 1, the solar irradiance prediction system of soft X-rays and EUV wavelength ranges according to an embodiment of the present disclosure preferably includes a data input unit 100, a data pre-processing unit 200, a model processing unit 300, and a data post-processing unit 400.

Each component preferably performs operations by being configured separately in multiple operation processing means including a CPU or being integrated into one operation processing means.

Each component will be described in detail.

Preferably, when solar flare alert of a preset level or higher is issued, the data input unit 100 receives data of preset items regarding the issued solar flare alert.

Here, the preset level is set to M1 or higher, which may have an effect when solar irradiance due to the occurring flare reaches the Earth's ionosphere, but this is only an embodiment of the present disclosure.

The level of this solar flare alert is determined based on a flux of a soft-X rays wavelength range (0.1 to 0.8 nm) of a geostationary operational environmental satellite (GOES), and is provided in real time by the Space Weather Forecast Center (SWPC) of the National Oceanic and Atmospheric Administration (NOAA).

In this regard, when the solar flare alert of M1 level or higher is issued, it is preferable that the data input unit 100 receives data of an item that includes issued alert level information, occurrence time information, an occurring location information, and irradiance data in the soft-X rays wavelength range by the GOES at a time when solar flare alert is issued.

In this case, through the Space Weather Forecast Center (SWPC) of the National Oceanic and Atmospheric Administration (NOAA), the irradiance data in the soft-X rays wavelength range by the GOES may be obtained up to 7 days before based on the current time, and the data input unit 100 receives the irradiance data in the soft-X rays wavelength range by the GOES including the time when the solar flare alert (solar flare alert of M1 level or higher) is issued, that is, the irradiance data in the soft-X rays wavelength range up to 7 days before based on the current time.

It is preferable that the data pre-processing unit 200 analyzes the data (by the GOES including the occurring level information, the occurrence time information, the occurring location information, and the solar irradiance data for the soft-X ray wavelengths) by the data input unit 100, extracts the irradiance data from the occurrence time to a preset first time before based on the time when the corresponding solar flare alert is issued, and converts the extracted irradiance data into a preset time unit.

In detail, the data pre-processing unit 200 analyzes the data received by the data input unit 100, extracts the irradiance data from the occurrence time to the preset first time before based on the time when the corresponding solar flare alert is issued. In this case, it is preferable that the preset first time is 60 minutes. The preset first time is set to 60 minutes to reflect signs of solar flare before the solar flare occurs, but this is only an embodiment of the present disclosure and is not necessarily limited to 60 minutes. The preset first time may be increased or decreased taking into account data transfer rate, computation time for data analysis, etc.

However, in the data pre-processing unit 200 of the present disclosure, it is preferable to analyze the data received by the data input unit 100 and extract the irradiance data from the occurrence time to 60 minutes before based on the time when the corresponding solar flare alert is issued.

Thereafter, the data pre-processing unit 200 converts the extracted irradiance data into a preset time unit of 1 minute, thereby generating 60 irradiance data.

It is preferable that the model processing unit 300 inputs the irradiance data converted by the data pre-processing unit 200, that is, 60 irradiance data in 1-minute units from the occurrence time to 60 minutes before based on the time when the corresponding solar flare alert is issued, to the stored training model, and output the predicted irradiance data in the soft-X rays and EUV wavelength ranges according to the issued solar flare alert.

In this case, the predicted irradiance data is output as the predicted irradiance data from the occurrence time to a preset second time based on the time when the corresponding solar flare alert is issued.

In this case, it is preferable that the preset second time is 180 minutes. The preset second time is set to 180 minutes in order to reflect the time during which the electron density of the Earth's ionosphere is affected by the solar irradiance due to the occurring solar flare, but this is only an embodiment of the present disclosure and is not necessarily limited to 180 minutes. The preset second time may be increased or decreased in consideration of the data transfer rate, computation time for data analysis, and the level of the issued solar flare, etc.

However, by using the stored training model in the model processing unit 300 of the present disclosure, it is preferable that when the data pre-processing unit 200 inputs 60 irradiance data points in 1-minute units from 60 minutes before to the time of a solar flare alert, the system outputs 180 predicted irradiance data points in 1-minute units from the time of the alert to 180 minutes after.

In particular, the training model by the model processing unit 300 outputs the predicted irradiance data in the EUV wavelength range as well as the predicted irradiance data in the soft-X rays wavelength range according to the issued solar flare alert.

As described above, electron densities of ionosphere D and E layers increase due to the solar irradiance of the soft X-ray wavelength range, and an electron density of an ionosphere F layer increases due to the solar irradiance of the EUV wavelength range. However, institutions such as the Space Environment Forecast Center of the National Oceanic and Atmospheric Administration provide only the irradiance data in the soft X-ray wavelength range, and it is difficult to respond quickly to the increase in electron density in the ionosphere F layer, which actually causes ground-satellite radio communication to be disturbed and signal delays to occur.

To solve this problem, the present disclosure outputs the predicted irradiance data in the EUV wavelength range as well as the predicted irradiance data in the soft-X rays wavelength range according to the issued solar flare alert through the model processing unit 300.

It is preferable that the data post-processing unit 400 converts the predicted irradiance data output from the model processing unit 300, that is, the predicted irradiance data in the soft-X rays and EUV wavelength ranges in 1-minute units from the time when the solar flare alert is issued to 180 minutes after the time, into energy units to generate a predicted solar irradiance value.

That is, the predicted solar irradiance value means the predicted solar irradiance value in the soft-X rays and EUV wavelength ranges (a total of 105 wavelength ranges at 1 nm resolution) in 1-minute units from the time when the solar flare alert is issued to 180 minutes after the time.

The data post-processing unit 400 preferably uses the predicted solar irradiance value together with the irradiance data in the soft X-ray wavelength range by the GOES as a prediction/alert reference value of the space weather according to the occurring solar flare alert. In this way, there is an advantage in that it may more actively respond to radio interference caused by the entire ionosphere.

In addition, the data post-processing unit 400 may perform real-time ionosphere monitoring as well as the prediction of the above-described ionosphere change.

In detail, the data post-processing unit 400 preferably calculates a local time (LT) according to longitude using the predicted irradiance data in the soft-X rays and EUV wavelength ranges in 1-minute units from the time when the solar flare alert is issued to 180 minutes after the time, and determines whether the ionosphere effect occurs in real time during the day and night.

That is, the local time calculation by longitude calculates the local time (LT) by longitude using the predicted irradiance data based on the solar flare occurrence time (universal time (UT)).

Thereafter, based on the local time calculation result, it is preferable to determine day and night, determine the area where the ionosphere is greatly affected by the solar flare (for example, the area corresponding to LT 08-LT 16, which means daytime), analyze the ionosphere effect for each area, and provide an alert for this.

In order to store the training model in the model processing unit 300, the solar irradiance prediction system of soft X-rays and EUV wavelength ranges according to an embodiment of the present disclosure preferably includes a data collection unit 10, a data extraction unit 20, a data generation unit 30, and a training processing unit 40, as illustrated in FIG. 1.

It is preferable that the data collection unit 10 collects data of preset items for the issued solar flare alert in the past.

Specifically, in order to predict solar irradiance not only in the X-ray wavelength range but also in the EUV wavelength range through the above training model, the data collection unit 10 includes a first collection unit 11 and a second collection unit 12.

It is preferable that the first collection unit 11 collects, for each issued solar flare alert in the past, the level information, the occurrence time information, the occurring location information, and the irradiance data in the soft-X rays wavelength range by the GOES before the preset first time based on the time when the corresponding solar flare alert is issued.

In this case, as described above, the preset first time is preferably 60 minutes. The preset first time is set to 60 minutes to reflect signs of solar flare before the solar flare occurs, but this is only an embodiment of the present disclosure and is not necessarily limited to 60 minutes. The preset first time may be increased or decreased taking into account the data transfer rate, computation time for data analysis, etc.

However, in the data collection unit 10 of the present disclosure, it is preferable to extract, for each solar flare alert, the irradiance data from the occurrence time to 60 minutes before, based on the occurrence time when the corresponding solar flare alert is issued, in accordance with the operation of the data pre-processing unit 200 that generates the input data input to the training model.

The second collection unit 12 collects, using a linked observation database, the irradiance data in the soft-X rays wavelength range and the irradiance data in the EUV wavelength range corresponding to the data collected by the first collection unit 11.

That is, since it is intended to predict the solar irradiance not only in the soft X-ray wavelength range but also in the EUV wavelength range through the solar irradiance prediction system according to an embodiment of the present disclosure, EUV data is absolutely necessary in addition to the irradiance data in the soft X-ray wavelength range by the GOES.

Currently, the most powerful data covering all EUV data in the world and providing a vast amount of past actual measurement data, i.e., the observation database, is a FISM2 model. Accordingly, it is preferable that the second collection unit 12 is linked with the FISM2 to collect the irradiance data in the corresponding soft-X rays wavelength range and the irradiance data in the EUV wavelength range, for each issued solar flare alert in the past, which is data collected by the first collection unit 11.

The FISM2 model provides two modes, flare mode and daily mode, and it is preferable to use data of the flare mode in the present disclosure.

The flare mode of the FISM2 model is provided by dataizing irradiance data in units of 1 nm wavelength in 1 minute to the wave length range of 0.1 to 105 nm.

However, since data of the FISM2 model is in the form of a netcdf file format, it is preferable that the second collection unit 12 converts the data into irradiance data in units of w/m2.

In this case, it is preferable that the second collection unit 12 collects, for each solar flare alert by the data collected by the first collection unit 11, the corresponding irradiance data in the soft-X rays and EUV wavelength range for the preset second time based on the time when the corresponding solar flare alert is issued.

In this case, as described above, the preset second time is preferably 180 minutes. The preset second time is set to 180 minutes in order to reflect the time during which the electron density of the Earth's ionosphere is affected by the solar irradiance due to the occurring solar flare, but this is only an embodiment of the present disclosure and is not necessarily limited to 180 minutes. The preset second time may be increased or decreased in consideration of the data transfer rate, and the computation time for data analysis, etc.

However, it is preferable that the data collection unit 10 of the present disclosure collects, for each solar flare alert by the data collected by the first collection unit 11, the irradiance data from the occurrence time to 180 minutes after the occurrence time based on the time when the corresponding solar flare alert is issued, in accordance with the operation of the model processing unit 300.

It is preferable that the data extraction unit 20 analyzes the data collected by the data collection unit 10 and extracts data for generating training data.

That is, the data extraction unit 20 analyzes, for each issued solar flare alert in the past by the data collection unit 10, the level information, the occurrence time information, the occurring location information, the irradiance data in the soft-X rays wavelength range by the GOES from the occurrence time to 60 minutes before based on the time when the corresponding solar flare alert is issued, and the irradiance data in the soft-X rays wavelength range and the irradiance data in the EUV wavelength range from the occurrence time to 180 minutes after the occurrence time based on the time when the corresponding solar flare alert is issued.

To this end, as illustrated in FIG. 1, the data extraction unit 20 includes a first extraction unit 21, a second extraction unit 22, a third extraction unit 23, and a final processing unit 24.

It is preferable that the first extraction unit 21 analyzes the data collected by the data collection unit 10 and extracts data by solar flare alerts of a level higher than a preset level.

Since the R alert, which is the alert standard for Radio Blackout in the space environment, is used as the standard in the present disclosure, it is preferable that the first extraction unit 21 extract only data related to solar flare alerts of M1 or higher in which R1 or higher is issued.

In this case, the R alert used as the standard in the present disclosure is set to a level higher than or equal to a level that may have an impact when solar irradiance due to the issued solar flare reaches the Earth's ionosphere, but this is only an embodiment of the present disclosure.

The second extraction unit 22 analyzes the data extracted by the first extraction unit 21, and preferably removes the data by the corresponding solar flare alert, when a solar flare alert of a level higher than or equal to the preset level is issued duplicately from the occurrence time to the preset first time based on the time when the corresponding solar flare alert is issued.

That is, the second extraction unit 22 analyzes only the data primarily extracted through the first extraction unit 21, and analyzes data from the occurrence time to 60 minutes before, which is the preset first time, based on the occurrence time of any one solar flare alert, and thus, when a flare of a M1 level or higher that is the preset level or higher is issued during the corresponding period (from the occurrence time to 60 minutes before), i.e., when a duplicate flare occurs during the period to be analyzed, excludes the collected data related to the corresponding solar flare alert.

In short, the second extraction unit 22 excludes all the collected data related to the corresponding solar flare alert when the duplicate flare occurs during the time from the occurrence time to 60 minutes before based on the time when any one solar flare alert is issued.

The third extraction unit 23 analyzes the data remaining after being removed by the second extraction unit 22, and it is preferable to remove the data by the corresponding solar flare alert when the solar flare alert of the preset level or higher is issued duplicately during the preset second time from the occurrence time based on the time when the corresponding solar flare alert is issued.

That is, the third extraction unit 23 analyzes only the data secondarily extracted through the second extraction unit 22, and analyzes the data from the occurrence time to the 180 minutes after the occurrence time, which is the preset second time, based on the time when any one solar flare alert is issued, and thus, when a flare of M1 level or higher that is the preset level occurs during the corresponding period (from the occurrence time to 180 minutes after the occurrence time), i.e., when the duplicate flare occurs during the period to be analyzed, excludes the collected data related to the corresponding solar flare alert.

In short, the third extraction unit 23 excludes all the collected data related to the corresponding solar flare alert when the duplicate flare occurs during the time from the occurrence time to 180 minutes after the occurrence time based on the time when any one solar flare alert is issued.

In this case, the preset first time and the preset level by the second extraction unit 22 and the preset second time and the preset level by the third extraction unit 23 are merely an embodiment of the present disclosure as described above, and are not necessarily limited thereto.

It is preferable that the final processing unit 24 sets the data remaining after being removed by the third extraction unit 23 as the data for generating the training data.

That is, the data extraction unit 24 extracts and sets for each solar flare alert, as the data for generating the training data, the level information, the occurrence time information, the occurring location information, the irradiance data in the soft-X rays wavelength range by the GOES from the occurrence time to 60 minutes based on the time when the corresponding solar flare alert is issued, and the irradiance data in the soft-X rays wavelength range and the irradiance data in the EUV wavelength range from the occurrence time to 180 minutes after the occurrence time based on the time when the corresponding solar flare alert is issued, by using the final data thirdly extracted through the third extraction unit 23.

It is preferable that the data generation unit 30 extracts the corresponding irradiance data for each issued solar flare alert by using the data set by the data extraction unit 20, and generates the training data set by converting the extracted irradiance data into the preset time unit.

Specifically, the data generation unit 30 extracts the corresponding irradiance data (the irradiance data in the soft X-ray wavelength range by the GOES from the occurrence time to 60 minutes before based on the time when the corresponding solar flare alert is issued, the irradiance data in the soft X-ray wavelength range and the irradiance data of the EUV wavelength range from the occurrence time to 180 minutes after the occurrence time based on the time when the corresponding solar flare alert is issued) for each solar flare alert by using the data (for each solar flare alert, the level information, the occurrence time information, the occurring location information, the irradiance data of the soft X-ray wavelength range by the GOES from the occurrence time to 60 minutes before based on the time when the corresponding solar flare alert is issued, and irradiance data in the soft X-ray wavelength range and irradiance data in the EUV wavelength range from the occurrence time to 180 minutes based on the time when the corresponding solar flare alert is issued) set by the data extraction unit 20.

The extracted irradiance data is converted into a preset time unit of 1 minute to generate a total of 240 irradiance data, thereby generating the training data set.

That is, the training data set is generated for each issued solar flare alert by using the level information, the occurrence time information, the occurring location information, and 240 irradiance data.

It is preferable that the training processing unit 40 performs training on the training data set generated by the data generation unit 30 using a pre-stored artificial intelligence algorithm, and generates the training model.

In detail, the training processing unit 40 classifies the training data set generated by the data generation unit 30 at a ratio of training 9: verification 1: test 1 in order to smoothly classify the training data set. In detail, a training data set by an M-class flare alert and a training data set by an X-class flare alert are listed separately and classified using a 9:1:1 classification technique in chronological order.

The training processing unit 40 uses a fully connected layer time series technique, which is one of multi-layer perceptron (MLP) series, as a pre-stored artificial intelligence algorithm. However, this is only an embodiment of the present disclosure and is not necessarily limited thereto. However, for a smooth explanation, the training process will be described based on the fully connected layer time series technique.

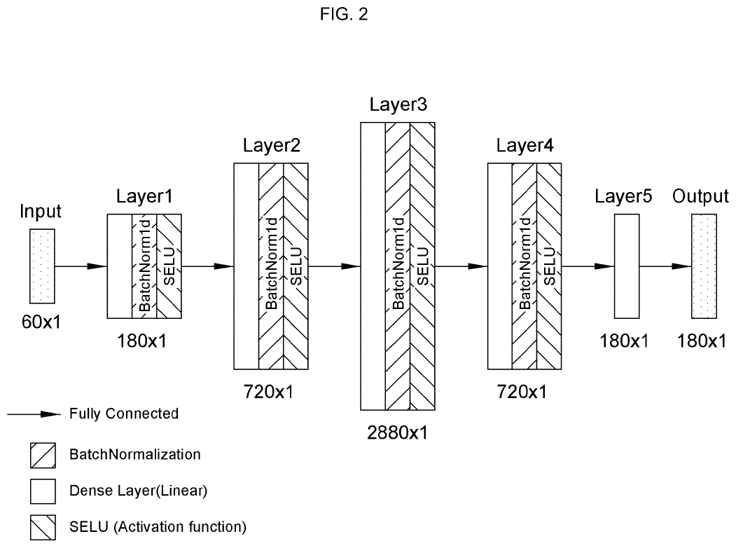

The training processing unit 40 preferably uses the fully connected layer time series technique, which means that all neurons in a previous layer are connected to all neurons in a next layer, as illustrated in FIG. 2, and includes a dense layer, a batch normalization layer, and a scaled exponential linear unit (SELU) layer configured in each layer except for an input layer, an output layer, and a previous output layer.

The dense layer is a layer with a dense structure in which both input neurons and output neurons are connected. Since 60 data, which is the input value of the training model, and 180 data, which is the output value, do not match, the dense layer is preferably designed as 4 layers so that the number is increased linearly at each step and then decreased again to produce 180 output values.

The batch normalization layer is a layer that normalizes the distribution of input data corresponding to each dense layer. In the present disclosure, the batch size is set to 5. This is called a mini batch, and the operation is performed by calculating the average variance of other input data of each mini batch. In this way, the data normalization is performed, and by arranging the batch normalization layer at a later stage of the dense layer for each layer, the training efficiency and accuracy in each layer may be improved.

The SELU layer is an activation function that scales the output value between 0 and 1, and is a function that further improves ELU, which surpasses the performance of all other ReLUs. The problem of vanishing gradient, which occurs when the gradient is lost, may be solved. In the present disclosure, by designing a neural network by stacking only fully connected layers and using SELU, the performance of the training model may be improved due to the self-normalizing effect of the network output value. To this end, the SELU activation function is designed at the last stage of each layer to improve the performance.

As described above, the training processing unit 40 performs the training on the training data set using the designed network, calculates a loss function between the measured value (actual value, data collected by FISM2) and the predicted value (output value), and applies an optimization function (for example, ADAM optimizer) to the calculated loss function to optimize the weights and perform repeated training so that the minimum loss function occurs.

It is preferable that the training model according to the training processing result by the training processing unit 40 is the training model stored in the model processing unit 300.

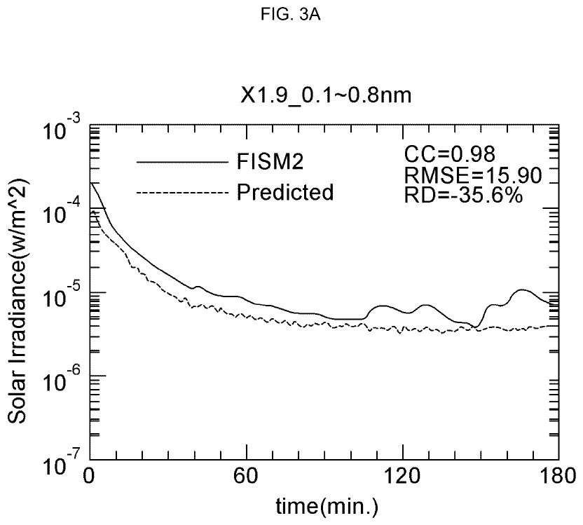

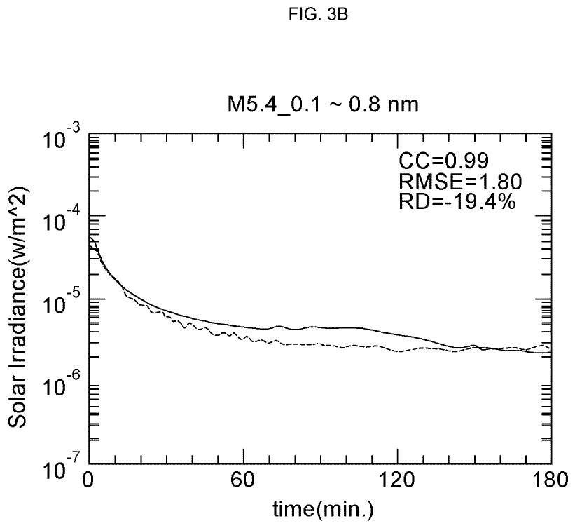

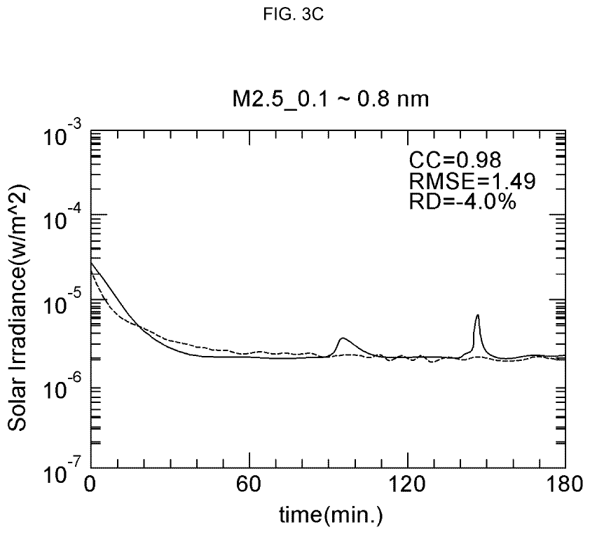

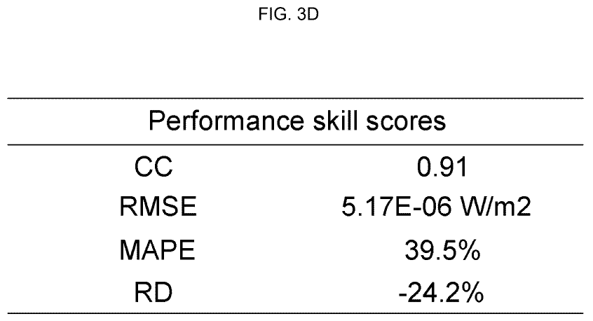

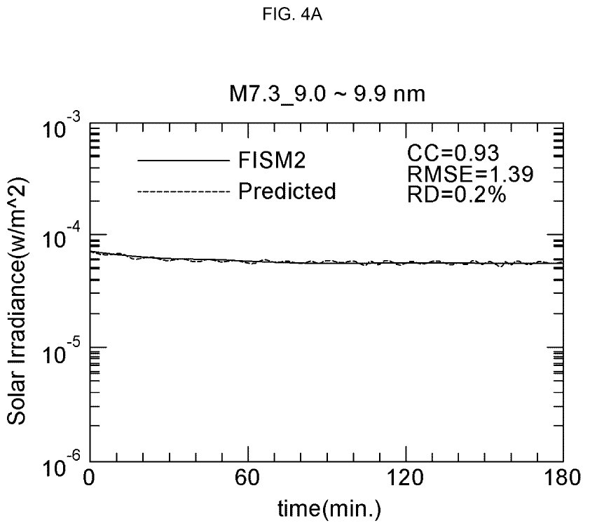

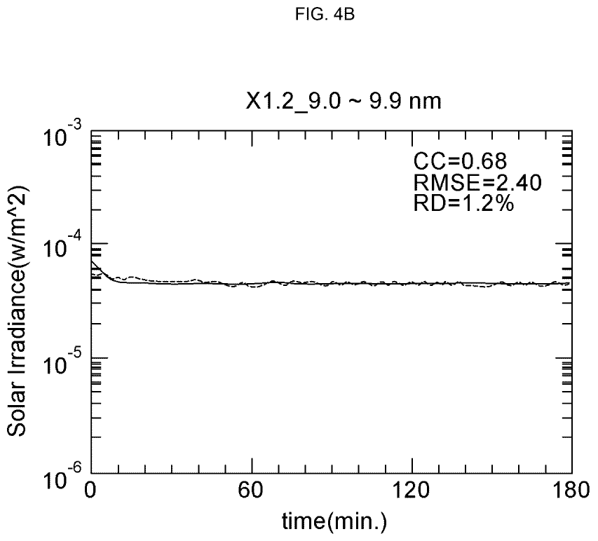

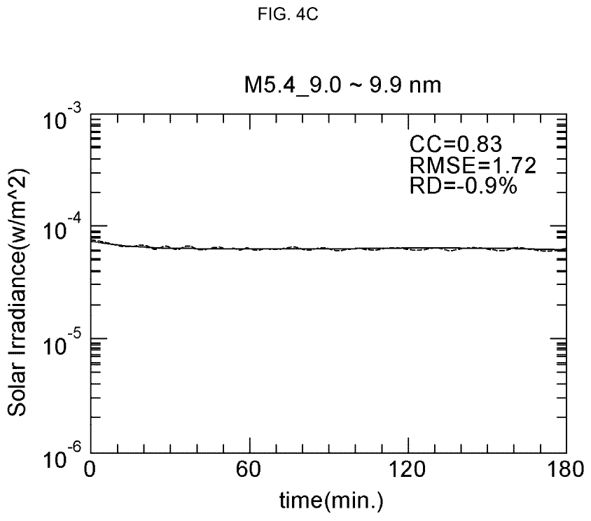

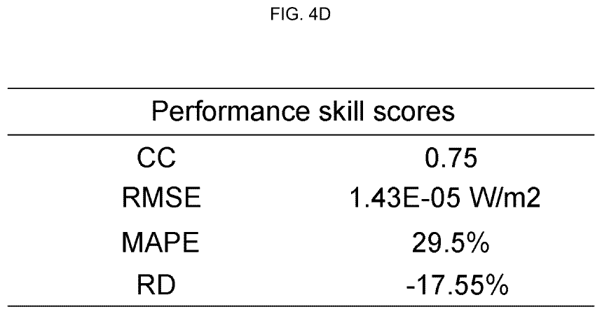

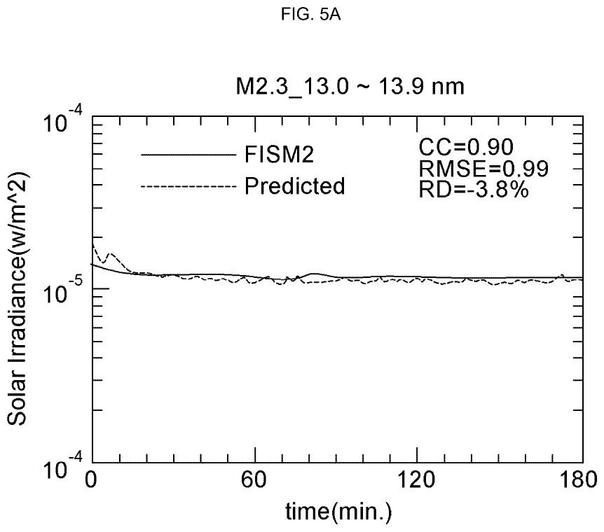

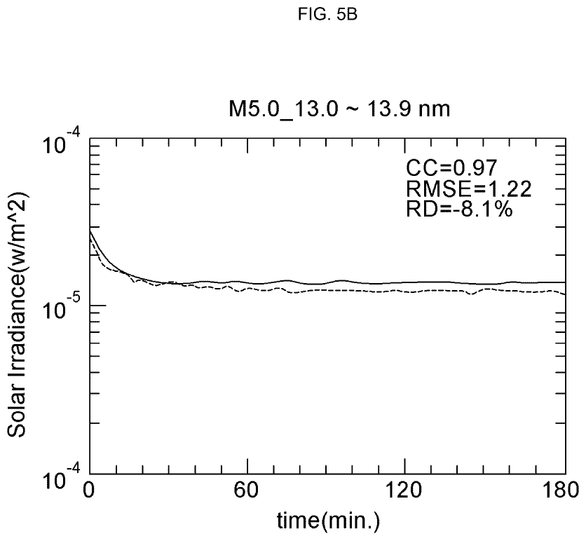

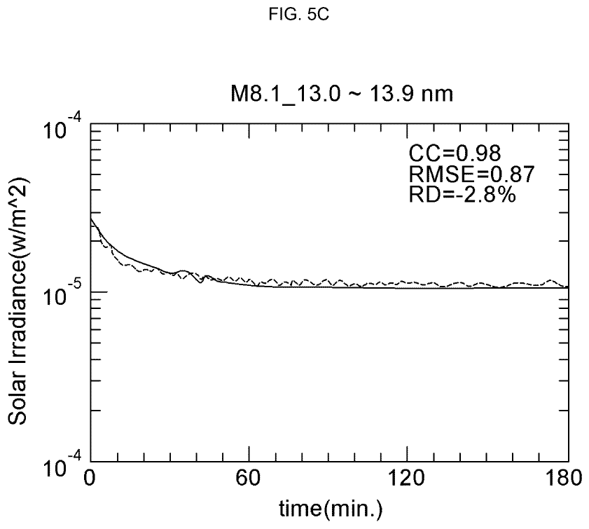

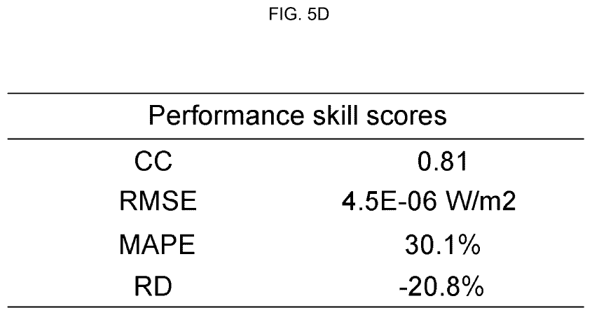

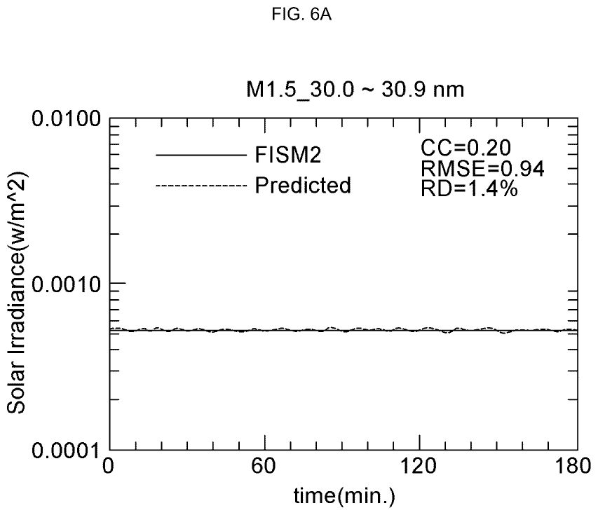

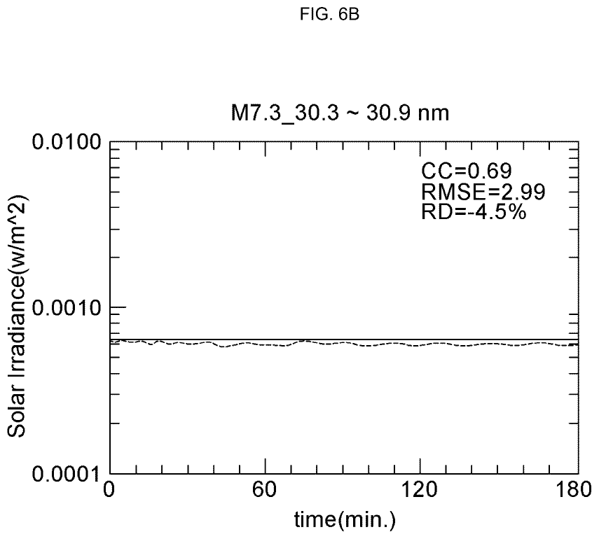

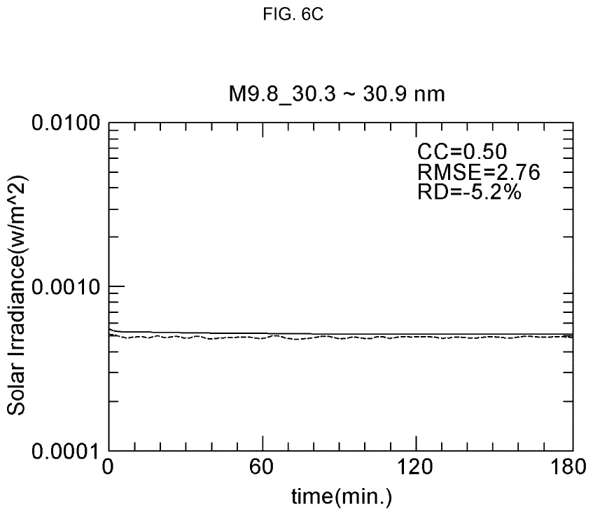

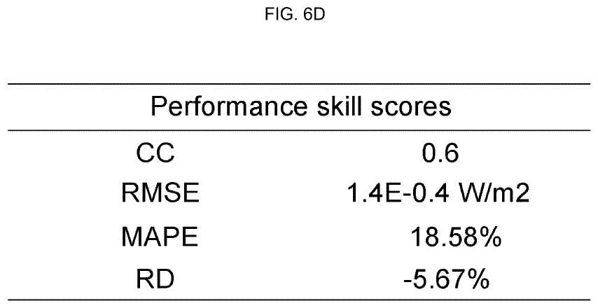

The present disclosure performed the verification of the prediction accuracy of the training model by the training processing unit 40, and as a result, it was found that a high prediction rate is illustrated as illustrated in FIGS. 3A-3D, 4A-4D, 5A-5D and 6A-6D.

Specifically, as a result to verifying four representative wavelength ranges (0.1 to 0.8 nm, 9.0 to 9.9 nm, 13.0 to 13.9 nm, and 30.0 to 30.9 nm) among the 105 wavelength ranges output as examples for verification, as illustrated in FIGS. 3A-3D, 4A-4D, 5A-5D and 6A-6D, by comparing the measured values (actual values, data collected by FISM2) and the predicted values (output values), it was found that a high prediction rate is shown.

It is preferable that the model processing unit 300 inputs irradiance data in 60 soft-X rays wavelength ranges in 1-minute units from the occurrence time to 60 minutes before when the solar flare alert of a level higher than the preset level is issued by using a training model according to the training processing result by the training processing unit 40, and thus, outputs irradiance data from in 180 soft-X rays wavelength ranges in 1-minute units from the occurrence time to 180 minutes after the occurrence time to the EUV wavelength range.

By using the output result by the model processing unit 300, the data post-processing unit 400 uses the predicted solar irradiance value together with the irradiance data in the soft X-ray wavelength range by the GOES to utilize the predicted solar irradiance value as the prediction/alert reference value of the space weather according to the issued solar flare alert.

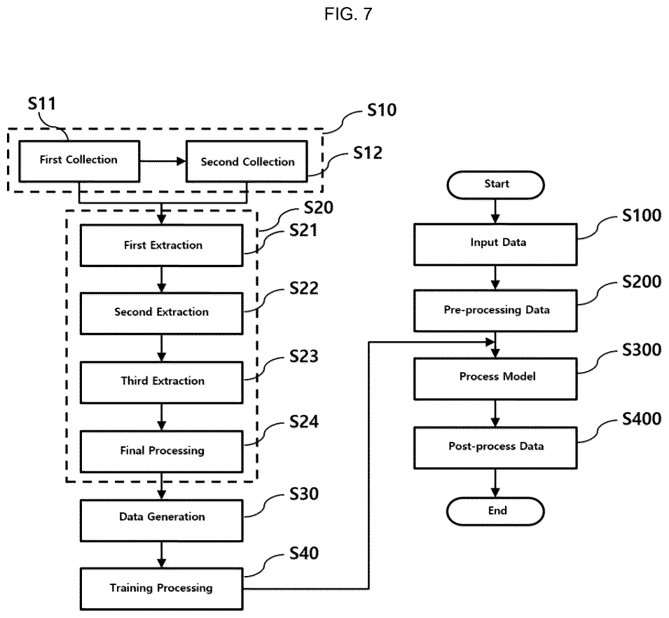

FIG. 7 is an exemplary flowchart illustrating solar irradiance prediction method of soft-X rays and EUV wavelength ranges according to an embodiment of the present disclosure, and as illustrated in FIG. 7, a solar irradiance prediction method of soft-X rays and EUV wavelength ranges according to an embodiment of the present disclosure includes a data input step (S100), a data pre-processing step (S200), a model processing step (S300), and a data post-processing step (S400).

Each step is performed through a solar irradiance prediction system of soft X-rays and EUV wavelength ranges, which is operated by being configured individually or integrated into one operation processing means including a CPU in multiple operation processing means.

Each step will be described in detail.

In the data input step (S100), when the solar flare alert of the preset level or higher is issued in the data input unit 100, data of preset items for the issued solar flare alert is input.

Here, the preset level is set to M1 or higher, which may have an effect when solar irradiance due to the occurring flare reaches the Earth's ionosphere, but this is only an embodiment of the present disclosure.

In this regard, in the data input step (S100), when the solar flare alert of M1level or higher is issued, the data of the item that includes the occurring level information, the occurrence time information, the occurring location information, and the irradiance (irradiance) data in the soft-X rays wavelength range by the GOES at the time when issued solar flare alert is received.

In the data pre-processing step (S200), the data post-processing unit 200 analyzes the data (by the GOES including the occurring level information, the occurrence time information, the occurring location information, and the occurrence time for the issued solar flare alert) by the data input step (S100), extracts the irradiance data from the occurrence time to the preset first time before based on the time when the corresponding solar flare alert is issued, and converts the extracted irradiance data into a preset time unit.

In detail, in the data pre-processing step (S200), the data received in the data input step (S100) is analyzed, and thus, the irradiance data from the occurrence time to the preset first time before based on the time when the corresponding solar flare alert is extracted. In this case, it is preferable that the preset first time is 60 minutes. The preset first time is set to 60 minutes to reflect signs of solar flare before the solar flare occurs, but this is only an embodiment of the present disclosure and is not necessarily limited to 60 minutes. The preset first time may be increased or decreased taking into account the data transfer rate, and the computation time for data analysis, etc.

In detail, in the data pre-processing step (S200) the data received in the data input step (S100) is analyzed, and thus, the irradiance data from the occurrence time to 60 minutes before based on the time when the corresponding solar flare alert is extracted.

Thereafter, the data pre-processing unit 200 converts the extracted irradiance data into a preset time unit of 1 minute, thereby generating 60 irradiance data.

In the model processing step (S300), the model processing unit 300 inputs the irradiance data converted in the data pre-processing step (S200), that is, 60 irradiance data in 1-minute units from the occurrence time to 60 minutes before based on the time when the corresponding solar flare alert is issued, to the stored training model, and output the predicted irradiance data in the soft-X rays and EUV wavelength ranges according to the issued solar flare alert.

In this case, the predicted irradiance data is output as the predicted irradiance data from the occurrence time to the preset second time based on the time when the corresponding solar flare alert is issued.

In this case, it is preferable that the preset second time is 180 minutes. The preset second time is set to 180 minutes in order to reflect the time during which the electron density of the Earth's ionosphere is affected by the solar irradiance due to the occurring solar flare, but this is only an embodiment of the present disclosure and is not necessarily limited to 60 minutes. The preset second time may be increased or decreased in consideration of the data transfer rate, and the computation time for data analysis etc.

According to the present disclosure, through the model processing step (S300), by using the stored training model, when in the data pre-processing step (S200), 60 irradiance data are input in 1-minute units from the occurrence time to 60 minutes before based on the time when the corresponding solar flare alert is issued, 180 irradiance data in 1-minute units from the occurrence time to 180 minutes after the occurrence time based on the time when the corresponding solar flare alert are output.

The predicted irradiance data is output as the predicted irradiance data in the EUV wavelength range as well as the predicted irradiance data in the soft-X rays wavelength range according to the issued solar flare alert.

In the data post-processing step (S400), the data post-processing unit 400 converts the predicted irradiance data output from the model processing step (S300), that is, the predicted irradiance data in the soft-X rays and EUV wavelength ranges in 1-minute units from the time when the solar flare alert is issued to 180 minutes after the time, into energy units to generate a predicted solar irradiance value.

That is, the predicted solar irradiance value means the predicted solar irradiance value in the soft-X rays and EUV wavelength ranges (a total of 105 wavelength ranges) in 1-minute units from the time when the solar flare alert is issued to 180 minutes after the time.

Thereafter, in the data post-processing step (S400), it is preferable that the predicted solar irradiance value together with the irradiance data in the soft X-ray wavelength range by the GOES is utilized as a prediction/alert reference value of the space weather according to the issued solar flare alert. In this way, there is an advantage in that it may more actively respond to radio interference caused by the entire ionosphere.

In addition, in the data post-processing step (S400), the real-time ionosphere monitoring as well as the prediction of the above-described ionosphere change may be performed.

In detail, in the data post-processing step (S400) it is preferable to calculate the local time (LT) according to longitude using the predicted irradiance data in the soft-X rays and EUV wavelength ranges in 1-minute units from the time when the solar flare alert is issued to 180 minutes after the time, and determine whether the ionosphere effect occurs in real time during the day and night.

That is, the local time calculation by longitude calculates the local time (LT) by longitude using the predicted irradiance data based on the solar flare occurrence time (universal time (UT)).

Thereafter, based on the local time calculation result, it is preferable to determine day and night, determine the area where the ionosphere is greatly affected by the solar flare (for example, the area corresponding to LT 08-LT 16, which means daytime), analyze the ionosphere effect for each area, and provide an alert for this.

According to an embodiment of the present disclosure, the solar irradiance prediction method of soft-X rays and EUV wavelength ranges further includes a data collection step (S10), a data extraction step (S20), a data generation step (S30), and a training processing step (S40) to store the training model before performing the model processing step (S300), as illustrated in FIG. 7.

In the data collection step (S10), the data of the preset item for the issued solar flare alerts in the past in the data collection unit 10 is collected.

Specifically, in order to predict solar irradiance not only in the X-ray wavelength range but also in the EUV wavelength range through the training model, the data collection step (S10) includes a first collection step (S11) and a second collection step (S12).

In the first collection step (S11), the level information, the occurrence time information, the occurring location information, and the irradiance data in the soft-X rays wavelength range by the GOES before the preset first time based on the time when the corresponding solar flare alert is issued are collected for each issued solar flare alert in the past.

In this case, as described above, the preset first time is preferably 60 minutes. The preset first time is set to 60 minutes to reflect signs of solar flare before the solar flare occurs, but this is only an embodiment of the present disclosure and is not necessarily limited to 60 minutes. The preset first time may be increased or decreased taking into account communication speed, data analysis speed, etc.

However, in the data collection step 10 of the present disclosure, the irradiance data from the occurrence time to 60 minutes before based on the occurrence time when the corresponding solar flare alert is issued is extracted for each solar flare alert in accordance with the operation of the data pre-processing unit 200 that generates the input data input to the training model.

In the second collection step (S12), by using the linked observation database, the irradiance data in the soft-X rays wavelength range and the irradiance data in the EUV wavelength range corresponding to the data collected by the first collection unit 11 are collected.

That is, since the present disclosure intends to predict the solar irradiance not only in the soft X-ray wavelength range but also in the EUV wavelength range, the EUV data is absolutely necessary in addition to the irradiance data in the soft X-ray wavelength range by the GOES.

Currently, the most powerful data covering all EUV data in the world and providing a vast amount of past actual measurement data, i.e., the observation database, is a FISM2 model. Accordingly, it is preferable that the second collection unit 12 is linked with the FISM2 to collect the irradiance data in the corresponding soft-X rays wavelength range and the irradiance data in the EUV wavelength range, for each issued solar flare alert in the past, which is data collected by the first collection unit 11.

The FISM2 model provides two modes, flare mode and daily mode, and it is preferable to use data of the flare mode in the present disclosure.

The flare mode of the FISM2 model is provided by dataizing irradiance data in units of 1 nm wavelength in 1 minute to the wave length range of 0.1 to 105 nm.

However, since data of the FISM2 model is in the form of a netcdf file format, it is preferable that the second collection unit 12 converts the data into irradiance data in units of w/m2.

In this case, in the second collection step (S12), the corresponding irradiance data in the soft-X rays wavelength range and the irradiance data in the EUV wave length range for the preset second time based on the time when the corresponding solar flare alert are collected for each issued solar flare alert by the data collected in the first collection step (S11).

In this case, as described above, the preset second time is preferably 180 minutes. The preset second time is set to 180 minutes in order to reflect the time during which the electron density of the Earth's ionosphere is affected by the solar irradiance due to the occurring solar flare, but this is only an embodiment of the present disclosure and is not necessarily limited to 60 minutes. The preset second time may be increased or decreased in consideration of the data transfer rate, and the computation time for data analysis, etc.

However, in the data collection step (S10) of the present disclosure, it is preferable that the irradiance data from the occurrence time to 180 minutes after the occurrence time based on the time when the corresponding solar flare alert is issued is collected for each solar flare alert by the data collected in the first collection step (S11) in accordance with the operation of the model processing unit 300.

In the data extraction step (S20), the data extraction unit 20 extracts the data for generating the training data by analyzing the data collected in the data collection step (S10).

In the data extraction step (S20), the level information, the occurrence time information, the occurring location information, the irradiance data in the soft-X rays wavelength range by the GOES from the occurrence time to 60 minutes before based on the time when the corresponding solar flare alert is issued, and the irradiance data in the soft-X rays wavelength range and the irradiance data in the EUV wavelength range from the occurrence time to 180 minutes after the occurrence time based on the time when the corresponding solar flare alert are analyzed for each issued solar flare alert in the past.

To this end, the data extraction step (S20) includes a first extraction step (S21), a second extraction step (S22), a third extraction step (S23), and a final processing step (S24), as illustrated in FIG. 7.

In the first extraction step (S21), the data is analyzed in the data collection step (S10) to extract the data by the solar flare alert of a level higher than a preset level.

Since the R alert, which is the alert standard for Radio Blackout in the space environment, is used as the standard in the present disclosure, it is preferable that the first extraction unit 21 extract only data related to solar flare alert of M1 or higher in which R1 or higher is issued.

In this case, the R alert used as the standard in the present disclosure is set to a level higher than or equal to a level that may have an impact when solar irradiance due to the occurring flare reaches the Earth's ionosphere, but this is only an embodiment of the present disclosure.

In the second extraction step (S22), the data extracted in the first extraction unit (S21) is analyzed, and thus, when the solar flare alert of a level higher than or equal to the preset level is issued duplicately from the occurrence time to the preset first time based on the time when the corresponding solar flare alert is issued, the data is removed by the corresponding solar flare alert.

In the second extraction step (S22), only the data primarily extracted through the first extraction unit 21 is analyzed, and data is analyzed from the occurrence time to 60 minutes before, which is the preset first time, based on the occurrence time of any one solar flare alert, and thus, when a flare of a M1 level or higher that is the preset level or higher occurs during the corresponding period (from the occurrence time to 60 minutes before), i.e., when a duplicate flare occurs during the period to be analyzed, the collected data related to the corresponding solar flare alert is excluded.

In short, in the second extraction step (S22), when the duplicate flare occurs during the time from the occurrence time to 60 minutes before based on the time when any one solar flare alert is issued, all the collected data related to the corresponding solar flare alert is removed.

In the third extraction step (S23), the data remaining after being removed in the second extraction step (S22) is analyzed, and thus, when the solar flare alert of the preset level or higher is issued duplicately during the preset second time from the occurrence time based on the time when the corresponding solar flare alert is issued, the data by the corresponding solar flare alert is removed.

That is, in the third extraction step (S23), only the data secondarily extracted in the second extraction step 22 is analyzed, and thus, the data from the occurrence time to the 180 minutes after the occurrence time, which is the preset second time, based on the time when any one solar flare alert is issued is analyzed, so when a flare of M1 level or higher that is the preset level occurs during the corresponding period (from the occurrence time to 180 minutes after the occurrence time), i.e., when the duplicate flare occurs during the period to be analyzed, the collected data related to the corresponding solar flare alert is excluded.

In short, in the third extraction step (S23), when the duplicate flare occurs during the time from the occurrence time to 180 minutes after the occurrence time based on the time when any one solar flare alert is issued, all the collected data related to the corresponding solar flare alert is excluded.

In the final processing step (S24), the data remaining after being removed by the third extraction step (S23) is set as the data for generating the training data.

In the final processing step (S24), as the data for generating the training data, the level information, the occurrence time information, the occurring location information, the irradiance data in the soft-X rays wavelength range by the GOES from the occurrence time to 60 minutes before based on the time when the corresponding solar flare alert is issued, and the irradiance data in the soft-X rays wavelength range and the irradiance data in the EUV wavelength range from the occurrence time to 180 minutes after the occurrence time based on the time when the corresponding solar flare alert is issued are extracted and set, for each solar flare alert, as the data for generating the training data by using the final data thirdly extracted in the third extraction step (S23).

In the data generation step (S30), the data generation unit 30 extracts the corresponding irradiance data for each issued solar flare alert by using the data extracted in the data extraction step (S20), and generates the training data set by converting the extracted irradiance data into the preset time unit.

Specifically, in the data generation step (S30), the corresponding irradiance data (the irradiance data in the soft X-ray wavelength range by the GOES from the occurrence time to 60 minutes before based on the time when the corresponding solar flare alert is issued, the irradiance data in the soft X-ray wavelength range and the irradiance data of the EUV wavelength range from the occurrence time to 180 minutes after the occurrence time based on the time when the corresponding solar flare alert is issued) is extracted for each solar flare alert by using the data (for each solar flare alert, the level information, the occurrence time information, the occurring location information, the irradiance data of the soft X-ray wavelength range by the GOES from the occurrence time to 60 minutes before based on the time when the corresponding solar flare alert is issued, and irradiance data in the soft X-ray wavelength range and irradiance data in the EUV wavelength range from the occurrence time to 180 minutes after the occurrence time) set in the data extraction step (S20).

The extracted irradiance data is converted into a preset time unit of 1 minute to generate a total of 240 irradiance data, thereby generating the training data set.

That is, the training data set is generated for each solar flare alert by using the level information, the occurrence time information, the occurring location information, and 240 irradiance data.

In the training processing step (S40), the training processing unit 40 performs the training on the training data set generated in the data generation step (S30) using the pre-stored artificial intelligence algorithm, and generates the training model.

In detail, in the training processing step (S40), the training data set generated in the data generation step (S30) is classified at a ratio of training 9:verification 1:test 1 in order to smoothly classify the training data set. In detail, a training data set by an M-class flare alert and a training data set by an X-class flare alert are listed separately and classified using a 9:1:1 classification technique in chronological order.

In the training processing step (S40), the fully connected layer time series technique, which is one of multi-layer perceptron (MLP) series, was used as the pre-stored artificial intelligence algorithm. However, this is only an embodiment of the present disclosure and is not necessarily limited thereto. However, for a smooth explanation, the training process will be described based on the fully connected layer time series technique.

In the training processing step (S40), as illustrated in FIG. 2, the fully connected layer time series technique, which means that all neurons in the previous layer are connected to all neurons in the next layer, is used, and preferably includes the dense layer, the batch normalization layer, and the scaled exponential linear unit (SELU) layer configured in each layer except for the input layer, the output layer, and the previous output layer.

The dense layer is a layer with a dense structure in which both input neurons and output neurons are connected. Since 60 data, which is the input value of the training model, and 180 data, which is the output value, do not match, the dense layer is preferably designed as 4 layers so that the number is increased linearly at each step and then decreased again to produce 180 output values.

The batch normalization layer is a layer that normalizes the distribution of input data corresponding to each dense layer. In the present disclosure, the batch size is set to 5. This is called a mini batch, and the operation is performed by calculating the average variance of other input data of each mini batch. In this way, the data normalization is performed, and by arranging the batch normalization layer after the dense layer for each layer, the training efficiency and accuracy in each layer may be improved.

The SELU layer is an activation function that scales the output value between 0 and 1, and is a function that further improves ELU, which surpasses the performance of all other ReLUs. The problem of vanishing gradient, which occurs when the gradient is lost, may be solved. In the present disclosure, by designing a neural network by stacking only fully connected layers and using SELU, the performance of the training model may be improved due to the self-normalizing effect of the network output value. To this end, the SELU activation function is designed at the last stage of each layer to improve the performance.

As described above, in the training processing step (S40), as described above, the training is performed on the training data set using the designed network, the loss function between the measured value (actual value, data collected by FISM2) and the predicted value (output value) is calculated, and the optimization function (for example, ADAM optimizer) is applied to the calculated loss function to optimize the weights and perform repeated training so that the minimum loss function occurs.

It is preferable that the training model according to the training processing result in the training processing step (S40) is the training model stored in the model processing step (S300).

The present disclosure performed the verification of the prediction accuracy of the training model in the training processing step (S40), and as a result, it was found that a high prediction rate is illustrated as illustrated in FIGS. 3A-3D, 4A-4D, 5A-5D and 6A-6D.

Specifically, as a result to verifying four representative wavelength ranges (0.1 to 0.8 nm, 9.0 to 9.9 nm, 13.0 to 13.9 nm, and 30.0 to 30.9 nm) among the 105 wavelength ranges output as examples for verification, as illustrated in FIGS. 3A-3D, 4A-4D, 5A-5D and 6A-6D, by comparing the measured values (actual values, data collected by FISM2) and the predicted values (output values), it was found that a high prediction rate is shown.

In this way, in the model processing step (S300), the irradiance data in 60 soft-X rays wavelength ranges in 1-minute units from the occurrence time to 60 minutes before when the solar flare alert of a level higher than the preset level is issued is input by using the training model according to the training processing result in the training processing step (S40), and thus, the irradiance data from in 180 soft-X rays wavelength ranges in 1-minute units from the occurrence time to 180 minutes after the occurrence time to the EUV wavelength range is output.

By using the output result in the model processing step (S300), in the data post-processing step (S400), the predicted solar irradiance value together with the irradiance data in the soft X-ray wavelength range by the GOES is used to utilize the predicted solar irradiance value as the prediction/alert reference value of the space weather according to the issued solar flare alert.

Meanwhile, in an embodiment of the present disclosure, an automatic creation of an artificial intelligence-based space environment log and a method thereof may be implemented in the form of a program command that may be executed through various electronic information processing means and recorded in a storage medium. The storage medium may include program commands, data files, data structures, or the like, alone or a combination thereof.

The program commands recorded in the storage medium may be especially designed and constituted for the present disclosure or be known to those skilled in a software field. Examples of the storage medium may include a magnetic medium such as a hard disk, a floppy disk, or a magnetic tape; an optical medium such as a compact disk read only memory (CD-ROM) or a digital versatile disk (DVD); a magneto-optical medium such as a floptical disk; and a hardware device specially configured to store and execute program commands, such as a ROM, a random access memory (RAM), a flash memory, or the like. Examples of the program commands include a high-level language code capable of being executed by an apparatus electronically processing information using an interpreter, or the like, for example, a computer, as well as a machine language code made by a compiler.

According to the present disclosure, by the solar irradiance prediction system and method of soft X-rays and EUV wavelength ranges, when the solar flare alert is issued, it is possible to predicting the solar irradiance within the wavelength range that may affect the Earth's ionosphere based on the corresponding point in time and rapidly provide the solar irradiance.

In this way, it is possible to predict the change in space weather due to the occurring solar flare and perform the prediction/alert accordingly.

The present disclosure has been described by specific matters such as detailed components, embodiments, and the drawings hereinabove, but they have been provided only for assisting in the entire understanding of the present disclosure, and the present disclosure is not limited to embodiments. Various modifications and changes may be made by those skilled in the art to which the present disclosure pertains from this description.

Therefore, the spirit of the present disclosure should not be limited to these embodiments, but the claims and all of modifications equal or equivalent to the claims are intended to fall within the scope and spirit of the present disclosure.

1. A solar irradiance prediction system of soft X-rays and EUV wavelength ranges, comprising:
when solar flare alert of a preset level or higher is issued, a data input unit that receives data of preset items for the issued solar flare alert;
a data pre-processing unit that analyzes the data received by the data input unit to extract irradiance data from an occurrence time to the preset first time before based on a time when a corresponding solar flare alert is issued and convert the extracted irradiance data into a preset time unit;
a model processing unit that inputs the irradiance data converted by the data pre-processing unit to a stored training model, and receives predicted irradiance data in the soft-X rays and EUV wavelength ranges; and
a data post-processing unit that converts the predicted irradiance data output from the model processing unit into an energy unit and generates a predicted solar irradiance value.

2. The solar irradiance prediction system of claim 1, wherein the model processing unit outputs the predicted irradiance data from the occurrence time to a preset second time.

3. The solar irradiance prediction system of claim 1, wherein the data input unit includes, as the preset item, level information, occurrence time information, occurring location, and irradiance data in the soft-X rays wavelength range by geostationary operational environmental satellite (GOES) at the time when the solar flare alert is issued.

4. The solar irradiance prediction system of claim 2, further comprising:
a data collection unit that collects data of a preset item for issued solar flare alert in the past;
a data extraction unit that analyzes the data collected by the data collection unit and sets data for generating training data;
a data generation unit that extracts, for each issued solar flare alert, the irradiance data using the data set by the data extraction unit and converts the extracted irradiance data into the preset time unit to generate a training data set; and
a training processing unit that performs training on the training data set generated by the data generation unit using a pre-stored artificial intelligence algorithm to generate a training model,
wherein the training model according to a training processing result of the training processing unit is a training model stored in the model processing unit.

5. The solar irradiance prediction system of claim 4, wherein the data collection unit includes:
a first collection unit that collects, for each issued solar flare alert in the past, level information, occurrence time information, an occurring location, and irradiance data in the soft-X rays wavelength range by GOES before the preset first time based on the time when the corresponding solar flare alert is issued; and
a second collection unit that collects, using a linked observation database, irradiance data in the soft-X rays wavelength range and irradiance data in the EUV wavelength range corresponding to the data collected by the first collection unit, and
the second collection unit collects data for the preset second time using the linked observation database based on the time when the corresponding solar flare alert is issued.

6. The solar irradiance prediction system of claim 5, wherein the data extraction unit includes:
a first extraction unit that analyzes the data collected by the data collection unit and extracts data by the solar flare alert of a preset level or higher;
a second extraction unit that analyzes the data extracted by the first extraction unit, and removes data by the corresponding solar flare alert, when the solar flare alert of the preset level or higher is issued duplicately from the occurrence time to the preset first time before based on the time when the corresponding solar flare alert is issued;
a third extraction unit that analyzes data remaining after being removed by the second extraction unit, and removes the data by the corresponding solar flare alert when the corresponding solar flare of the preset level or higher is issued duplicately from the occurrence time to the preset second time based on the time when the corresponding solar flare alert is issued; and
a final processing unit that sets the data remaining after being removed by the third extraction unit as the data for generating the training data.

7. A solar irradiance prediction method of soft-X rays and EUV wavelength ranges by a solar irradiance prediction system of soft X-rays and EUV wavelength ranges in which each step is performed by an operation processing means, the solar irradiance prediction method comprising:
a data input step of receiving, by a data input unit, as data of a preset item for an issued solar flare alert when solar flare alert of a preset level or higher is issued, level information, occurrence time information, an occurring location, and irradiance data in the soft-X rays wavelength range by a geostationary operational environmental satellite (GOES) of the time when the solar flare alert is issued;
a data pre-processing step of analyzing, by a data pre-processing unit, the data received in the data input step to extract irradiance data from an occurrence time to a preset first time before based on the time when the corresponding solar flare alert is issued and convert the extracted irradiance data into a preset time unit;
a model processing step of inputting, by a model processing unit, the irradiance data converted by the data pre-processing step to a stored training model, and receiving predicted irradiance data in the soft-X rays and EUV wavelength ranges from the occurrence time to a preset second time based on the time when the corresponding solar flare alert is issued; and
a data pre-processing step of converting, by a data post-processing unit, the predicted irradiance data output by the model processing step into an energy unit and generating the predicated irradiance data as a predicted solar irradiance value.

8. The solar irradiance prediction method of claim 7, further comprising:
prior to performing the model processing step,
a data collection step of collecting, by a data collection unit, data of a preset item for solar flare alert occurring in the past;
a data extraction step of analyzing, by a data extraction unit, the data collected in the data collection step and setting data for generating training data;
a data generation step of extracting, by a data generation unit, for each issued solar flare alert, the irradiance data using the data set by the data extraction step and converting the extracted irradiance data into a preset time unit to generate a training data set; and
a training processing step of performing, by a training processing unit, training on the training data set generated in the data generation step using a pre-stored artificial intelligence algorithm to generate a training model,
wherein the training model according to a training processing result in the training processing step is the training model in the model processing step.

9. The solar irradiance prediction method of claim 8, wherein the data collection step includes:
a first collection step of collecting, for each issued solar flare alert in the past, level information, occurrence time information, an occurring location, and irradiance data in the soft-X rays wavelength range by GOES before a preset first time based on the time when the corresponding solar flare alert is issued; and
a second collection step of collecting, using a linked observation database, the irradiance data in the soft-X rays wavelength range and irradiance data in the EUV wavelength range corresponding to the data collected in the first collection step, and
in the second collection step, data for a preset second time is collected using the linked observation database based on the time when the corresponding solar flare alert is issued.

10. The solar irradiance prediction method of claim 9, wherein the data extraction step includes:
a first extraction step of analyzing the data collected in the data collection step and extracting data by the solar flare alert of a preset level or higher;
a second extraction step of analyzing the data extracted by the first extraction unit, and removing data by the corresponding solar flare alert, when the corresponding solar flare alert of the preset level or higher is issued duplicately from the occurrence time to the preset first time before based on the time when the corresponding solar flare alert is issued;
a third extraction step of analyzing data remaining after being removed by the second extraction step, and removing data by the corresponding solar flare alert when the corresponding solar flare of the preset level or higher is issued duplicately from the occurrence time to the preset second time based on the time when the corresponding solar flare alert is issued; and
a final processing step of setting data remaining after being removed by the third extraction step as data for generating the training data.
